(19) United States
(12) Patent Application Publication
(10) Pub. No.: US 2002/0026391 A1
(43) Pub. Date: Feb. 28, 2002

(54) Method and system for collecting rich inventory via computer system

(76) Inventors: Scott A. Laster, Snohomish, WA (US); Theodore A. Carroll, Seattle, WA (US)

Correspondence Address: Ronald M. Anderson, Esq., Law Offices Of Ronald M. Anderson, Suite 507, 600 - 108th Avenue N.E., Bellevue, WA, 98004, US

(21) Appl. No.: 09/742,146

(22) Filed: Dec. 20, 2000

Related U.S. Application Data
(60) Provisional application No. 60/217,984, filed on Jul. 13, 2000.

(51) Int. Cl. G06F 17/60

(52) U.S. Cl. 705/28

(57) ABSTRACT

An efficient method for collecting rich inventory data including a unique control number, one or more parameters, image data, and/or audio data for each of a plurality of items being inventoried. A programmable digital camera (or a portable computer with an image capture system and microphone) is employed to collect the image data and/or audio data for the items. The unique control number is assigned for each item to be inventoried, and at least one parameter relating to the item is selected by a user from a pre-populated list of parameters. This list of parameters is appropriate for the type of inventory being collected, e.g., an inventory of goods to be auctioned over the Internet. Next, an image and/or brief audio description for the items is recorded. Alphanumeric data defining the selected parameter(s) and any image data or audio data are associated with the unique control number. If more items are to be inventoried, the unique control number is automatically incremented, and any parameters previously selected will be applied to a next item, unless a user affirmatively selects a different control number and changes the parameters. The resulting data are all linked together within an extensible markup language (XML) data structure. In the XML data structure, each item has a specific XML segment that includes the unique control number, any selected parameters, and the names of any image or audio data files. All the XML segments are stored in a single XML file.

### RELATED APPLICATION

This application is based on prior copending U.S. provisional patent application Serial No. 60/217,984 filed Jul. 13, 2000, the benefit of the filing date of which is hereby claimed under 35 U.S.C. § 119(e).

### FIELD OF THE INVENTION

This invention generally relates to the use of images in an inventory of materials and products, and more particularly to a system and method for using a digital camera to generate rich inventory data that includes images of the inventoried materials and products.

### BACKGROUND OF THE INVENTION

A statistical analysis of sales of goods by auction over the Internet shows that an item for sale illustrated in a picture sells much better that the same item simply described by text. Not only do pictures increase the likelihood of a sale, but items that are illustrated with pictures frequently command higher prices than do identical items that are sold without being illustrated in pictures. In certain businesses, such as auctions and other businesses involving the sale of a diverse inventory of used equipment, there will typically be a great number of different types of items that must be illustrated in catalogs that include other supporting data, if the items are likely to be sold. Without pictures illustrating the inventory that is for sale, and supporting data, the probability of a given item being sold for its maximum potential value in an online auction is relatively low.

The conventional procedure used to enter supporting data for each item in an inventory or catalog typically involves manually transcribing the information about the item onto a web page form, and using a standard photographic film based camera to record an image of the item. The film requires chemical processing, and then the resulting paper-based image must be converted to a digital image for inclusion in the on-line catalog or inventory. The manually transcribed data is input in an HTML format, and the digital image is linked to the HTML on the web page that will include the item. Using a digital camera instead of a photographic film-based camera eliminates the requirement to develop the film and scan the paper-based images to produce digital images, but associating the supporting textual data with the digital image of an item is still time consuming. Furthermore, this manual system may not retain a correlation between the supporting information about the item and an image of the item. It can be a prohibitively time consuming task to reorganize the data that has been collected and correlate it with the image of each item.

While the conventional process for creating a catalog or inventory of items for sale may be sufficient for an individual or small business that only occasionally employs online auctions to dispose of goods, such a procedure is impractical for high volume businesses that are continually turning over inventory and offering new goods for sale. As the volume of online auctioning is already considerable, and strong growth is expected in this area of Internet commerce, the need for a more efficient system is considerable. Note that Internet auction sites are now common; larger sites generate millions of dollars of sales on a daily basis, post hundreds of thousands of new items for auction every day, and can have more than a million items for sale at any one time. Such auction sites have provided a forum for individual entrepreneurs and small businesses to tap into a vast market that, absent such a forum, could not have otherwise been reached.

It would therefore be desirable to provide a user-friendly system that captures both images and text-based data for an item at the same time, so that the data and image are linked together initially, eliminating the requirement to correlate the data and images at a later time. Such a system should preferably be able to easily transfer the correlated image and textual data to a computer system, for posting to the Internet, for further manipulation of the data, and/or for archival purposes. It will be evident that such a system will be useful not only in preparing images and data for Internet auctions, but also for efficiently preparing general inventory data. Preferably, such a system would employ a digital image capturing component, means for capturing audio data and textual data, and a memory to store the captured data.

It should be noted that many digital image capturing devices enable a user to capture audio data as well as image data. Often such audio data is embedded within the data file containing the image data. When a significant amount of image data are generated, such as in a video clip, it is often critical to synchronize the audio data with the image data, and embedding the audio data with the image data enables such synchronization to more readily be achieved. However, in a system designed to capture audio data, image data, and text data relating to a specific inventory items, data management would be simplified if each type of data can be archived individually, yet remain linked together by the use of a common identifier, such as an inventory control number. It would thus be desirable to provide a system that enables audio data to be captured as a file separate from the image data file, to facilitate data management. The prior art does not disclose such a system.

### SUMMARY OF THE INVENTION

In accord with the present invention, a method is defined for generating rich inventory data, so that any image data, any audio data, and any alphanumeric text data relating to a specific inventory item are automatically correlated with a unique identifier assigned to the specific item, eliminating the need to manually correlate the data. In the method, a unique identifier is assigned to a specific item being inventoried. A user is enabled to select at least one parameter relating to the specific item from among a plurality of parameters, providing alphanumeric data for the specific item. The user is enabled to capture image and/or audio data relating to the specific item. The alphanumeric data, and the image data and/or audio data are stored in a memory and correlated with the unique identifier for the specific item. A data set is created by repeating these steps for each additional item to be inventoried.

Preferably, the unique identifier and the alphanumeric data are stored in a volatile memory, while any image data and audio data for the specific item are stored in a nonvolatile memory. The unique identifier and the alphanumeric data are copied from the volatile memory into a buffer memory, along with a file name of any image data and a file name of any audio data for the specific item. The contents of the buffer memory are then copied to the nonvolatile memory, and the buffer memory cleared.

Preferably, the identifier and the alphanumeric data are incorporated into an extensible markup language fragment, and the file names of any image data file and audio data file are included in the extensible markup language fragment. A complete set of extensible markup language data that includes the extensible markup language fragments for each of the items is copied to a master extensible markup language file in the nonvolatile memory.

Another aspect of the present invention is directed to an article of manufacture that includes a medium in which machine instructions are stored that cause a processor to implement functions generally consistent with the steps of the method discussed above.

A still further aspect of the present invention is directed to a system for enabling rich inventory data to be generated, so that all of the alphanumeric, image, and/or audio data relating to a specific item are linked using the unique identifier assigned to each specific item. This system enables alphanumeric data, audio data and image data to be generated and linked, and includes a memory in which a plurality of machine instructions are stored, a display, and a processor coupled to the memory and the display. The processor executes the machine instructions to implement functions that are generally consistent with the steps of the method discussed above.

### BRIEF DESCRIPTION OF THE DRAWING FIGURES

The foregoing aspects and many of the attendant advantages of this invention will become more readily appreciated as the same becomes better understood by reference to the following detailed description, when taken in conjunction with the accompanying drawings, wherein:

FIG. 1 is a flow chart illustrating the overall logic used by the present invention to generate a rich inventory;

FIG. 2 is a more detailed flow chart illustrating the logic used in a preferred embodiment of the present invention;

FIG. 3 is a block diagram showing the functional elements of a programmable digital camera suitable for implementing the method of the present invention;

FIG. 4 is a flow chart illustrating the logic used for controlling the programmable digital camera of FIG. 3;

FIG. 5 is a flow chart illustrating the logic used by the programmable digital camera of FIG. 3 in generating a rich inventory;

FIG. 6 is a flow chart illustrating the logic used in one embodiment for controlling the programmable digital camera of FIG. 3 in regard to displaying images and managing memory in the programmable digital camera;

FIG. 7 illustrates an exemplary Enter Control Number screen displayed by the programmable digital camera of FIG. 3;

FIG. 8 illustrates an exemplary Main Menu screen displayed by the programmable digital camera of FIG. 3;

FIG. 9 illustrates an exemplary Select Seller screen displayed by the programmable digital camera of FIG. 3;

FIG. 10 illustrates an exemplary Select Condition screen displayed by the programmable digital camera of FIG. 3;

FIG. 11 illustrates an exemplary Select Category screen displayed by the programmable digital camera of FIG. 3;

FIG. 12 illustrates an exemplary Take Pictures screen displayed by the programmable digital camera of FIG. 3;

FIG. 13 illustrates an exemplary New Item screen displayed by the programmable digital camera of FIG. 3; and

FIG. 14 illustrates an Exit screen displayed by the programmable digital camera of FIG. 3.

### DESCRIPTION OF THE PREFERRED EMBODIMENT

The present invention provides a method for generating rich inventory data that are suitable to be stored on a computer system or other digital memory media, or which can be manipulated, for example, to produce a catalog useable on an Internet auction site. The method can be implement either with a portable computer with attached hardware for capturing images and or audio, or with a programmable digital camera. The data generated can include alphanumeric (text) data files, image data files, and audio data files, all correlated or related to a unique control number assigned each item in the inventory. The method not only increases the speed with which inventory data can be collected, but also eliminates the requirement to manually correlate image data and/or audio data to alphanumeric data that are independently generated.

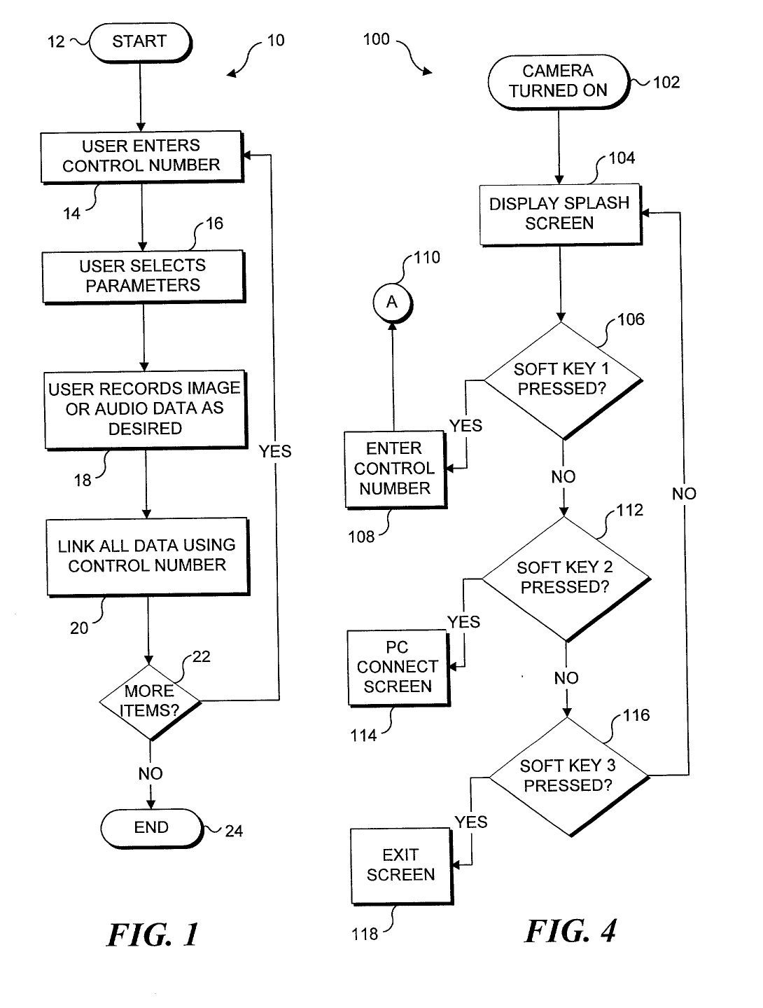

In FIG. 1 a flow chart 10 of the overall logic employed in the present invention begins at a start block 12, and proceeds to a block 14, in which the logic prompts a user to enter a unique control number for each item. It is also contemplated that the control number can be automatically assigned in sequential order as successive items are added to an inventory. The logic then flows to a block 16, in which a user can select at least one parameter relating to the current item from a pre-populated list of available parameters. Preferably the pre-populated list of parameters is developed based on the type of inventory being collected. For inventory data generated for an auction, these parameters will likely include a condition of the item, the auction forum at which item will be presented, and a category of goods to which the item relates (e.g., electronics, clothing, toys, etc.).

While it is anticipated that the present invention will be extremely useful in accumulating images and other inventory data for use in preparing to list a plurality of items for auction, either in a traditional live auction format or during an on-line auction on the Internet, it should be noted that the method of the present invention for generating rich inventory data is not limited to automating the collection of rich inventory data for an auction. The present invention is equally useful and applicable to any endeavor that requires the collection of an inventory and which preferably includes image data as well as alphanumeric and/or audio data. Thus, in embodiments of the invention directed toward generating rich inventory data for non-auction purposes, the pre-populated list of parameters will be optimized and modified to suit the particular purpose for which the inventory is being collected. For example, if the inventory is being collected for the purposes of tax information, it may be useful to include a date in service when a particular item was placed into service or a date of purchase as a user-selectable parameter, so that the rich inventory data generated can be used for preparing tax returns in which the depreciation of a particular asset owned by a business or corporation is included. If the present invention is used to collect inventory data for a warehouse that stockpiles consumer goods for resale, the parameters will likely include a Stock Keeping Unit (SKU) number, the quantity of products of each type, the package size of the product (individually packaged, packaged in cases of 12 units, etc.), any applicable expiration dates, the date a product was received in the warehouse, and the vendor from which a product was received.

After a user has selected the desired parameters from the pre-populated list of parameters, the next step in the logical sequence is indicated in a block 18, in which a user is prompted to record either an image and/or audio data for the current item, as desired. In a block 20, the parameter data and any image data and/or audio data are linked together using the control number entered in block 14. The next step in the method is represented by a decision block 22, in which a user is prompted to indicate whether any additional items are to be inventoried. If additional items are to be inventoried, the logic loops back to block 14, and the processes of entering a control number, selecting parameters, recording image data or audio data, and linking all the data together using the control number are repeated for the next item. If at decision block 22, a user indicates that no additional items are to be inventoried, the logical sequence is concluded, as is indicated by an end block 24.

It should be noted that rich inventory data can be linked together in various different ways in accord with the present invention. It is envisioned that the rich inventory data can be initially stored in a volatile memory, and then copied into nonvolatile memory in block 20, so that a directory is created, which is referenced by the control number, and all of the various kinds of data for that control number are saved as discrete files within that directory. However, rather than creating such a directory for each item inventoried, it would be preferable to create a single data file in which all of the information required to correlate the alphanumeric data, audio data, and image data generated by inventorying a group of items is stored.

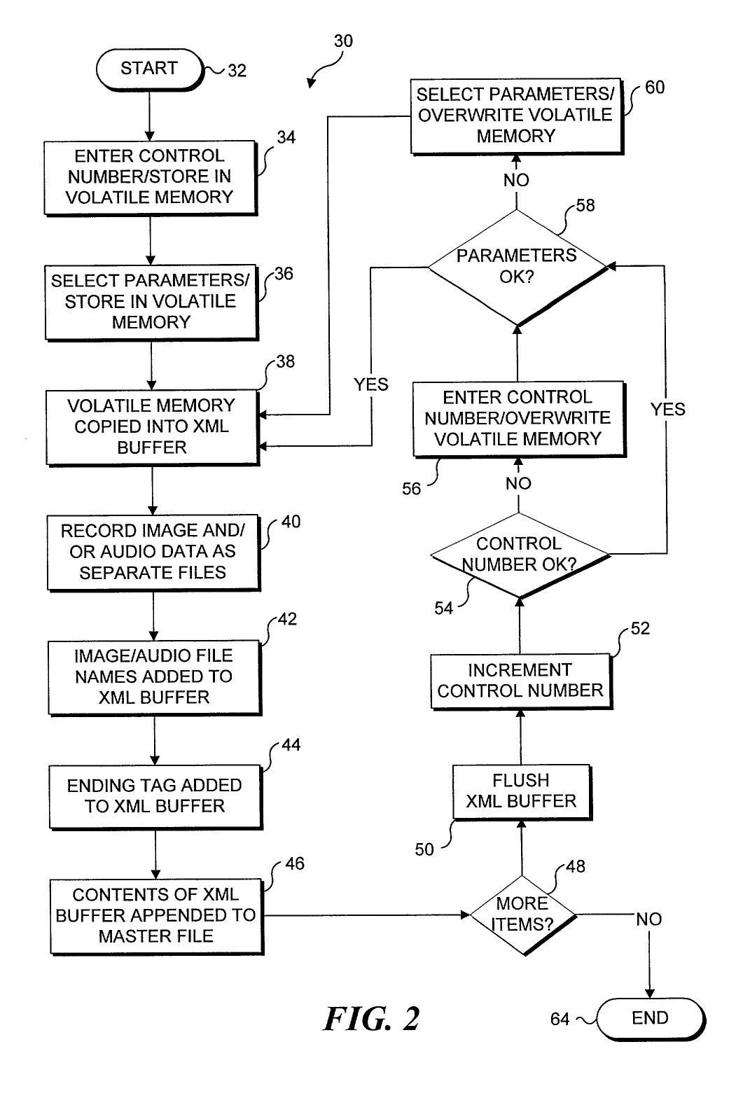

In FIG. 2, a flow chart 30 details the sequence of logical steps in a preferred embodiment in which all of the information required to correlate all of the data collected for a group of inventoried items are contained within a single file that is stored in nonvolatile memory. Flow chart 30 begins with a start block 32. At a block 34, a user is prompted to enter a control number, which is then stored in a volatile memory, e.g., in random access memory (RAM) on a computer. The logic then proceeds to a block 36, in which a user is prompted to select at least one parameter from a pre-populated list containing a plurality of parameters. The logic stores the selected parameters in the volatile memory. In a block 38, the contents of the volatile memory are copied into an Extensible Markup Language (XML) buffer. Note that the volatile memory has not yet been purged, and at this point the control number and selected parameters exist in both the XML buffer and the volatile memory.

The logic then proceeds to a block 40, in which a user is prompted to record image data and/or audio data for a current item, which the logic then saves as separate files. It should be noted that in the prior art, it is known to embed audio data within an image data file. However, in this preferred embodiment, the image data and audio data are stored as separate files. By splitting the image data and audio data into separate files, the present invention is able to ensure that the audio data for a single item are contained within a single file. In the prior art, audio data for one subject could be embedded in each of a plurality of related image data files.

Preferably, the audio data are created and stored using an Adaptive Differential Pulse Code Modulation (ADPCM) technique. ADPCM is a family of speech compression and decompression algorithms. A common implementation of this technique that is usable in the present invention takes 16-bit linear pulse code modulation samples and converts them to 4-bit samples, yielding a compression ratio of 4:1. There is public domain C code to implement this technique available via anonymous ftp at file://ftp.cwi.nl/pub/adpcm.shar. The ADPCM technique converts sound or analog information to binary information by taking frequent samples of the sound and expressing the value of the sampled sound modulation in binary terms. While prior ADPCM techniques are useful to embed audio data in image data files, the present invention preferably opens a separate file for the raw ADPCM data. Preferably, the unique control number identifying a specific item to which the sound data relates is used as the file name. Thus, for example, a specific item having a control number of 100′ might have a sound data file named 100.raw (“raw” being the extension used for ADPCM data).

After the logic has generated the desired audio data file and/or image data file, the next step in the logical sequence is represented by a block 42, in which the logic ensures that the names of any image data file and audio data file created in block 40 are added to the contents of the XML buffer created in block 38. The logic then proceeds to a block 44 in which an end tag is added to the contents of the XML buffer, thereby generating a complete segment of XML code. Next, in a block 46, the complete segment of XML code in the XML buffer (which now includes the control number, alphanumeric data corresponding to any selected parameters, any image data files names, and any audio data file names) is appended to a master file stored in a nonvolatile memory (e.g., on a hard drive or other nonvolatile or permanent storage media).

The logic then proceeds to a decision block 48, in which a user is prompted to indicate whether additional items need to be inventoried. If not, the logic proceeds to an end block 64.

If there are additional items to be inventoried, as indicated in a block 50, the XML buffer is flushed. After the XML buffer is flushed, a block 52 indicates that the control number is incremented. At this point, the logic flows to a decision block 54, in which a user is prompted to accept the incremented control number, which will be applied to a next item to be inventoried. If a user determines that the incremented control number is not satisfactory, a block 56 indicates that the user is prompted to enter a new control number, and the logic then overwrites the incremented control number in the volatile memory with the newly entered control number. A decision block 58 then determines whether the parameters are acceptable. If in response to decision block 54, the user had indicated that the incremented control number was satisfactory, the logic would have proceeded directly to decision block 58.

It should be noted that when the XML buffer is flushed in block 50, the volatile memory is not flushed, so that in decision block 58, the parameters selected in block 36 still exist unchanged in the volatile memory, even though in block 52 the control number was incremented. In decision block 58, the logic prompts the user to review the selected parameters stored in the volatile memory, and determine if all of those parameters are to be applied to the next item to be inventoried. If so, the logic returns to block 38, and the current contents of the volatile memory (either the incremented control number or the new control number, and the previously selected parameters) are copied into the XML buffer.

If in decision block 58, the user determines that any of the previously selected parameters are not applicable to the next (now current) item to be inventoried, or that additional parameters need to be selected for current item to be inventoried, the logic proceeds to a block 60, in which the user is prompted to change or add to the previously selected parameters stored in the volatile memory, as appropriate for the current item. Any changes overwrite the prior selected parameters in the volatile memory, and any newly selected parameters are added to the volatile memory. At this point in the sequence of logical steps, the logic moves to block 38, and the contents of the volatile memory are copied into the XML buffer, as previously described.

Once block 38 has been reached for any additionally inventoried items, the logic then repeats the sequence of logical steps described above, until at decision block 48, the user indicates that no further items remain to be inventoried (during the current session).

The logic illustrated in flow chart 30 ensures that the contents of the master file includes a distinct set of XML code or data for each different control number (and thus, for each item inventoried). Parsing the master XML file enables each individual XML segment corresponding to a specific item to be individually retrieved. The distinct segment of XML code or data for each item includes the unique control number for the item, any parameters selected for that specific item, the name of any image data file created for that item, and the name of any audio file created for that item. Thus, the XML data set for each specific inventory item completely links all the data generated for that specific inventory item. Note that while any image data file and audio data file are not contained within the XML file, that the names of any image and audio data files are contained within the XML, and thus can be retrieved as desired.

In a preferred embodiment, the present invention will be executed using a programmable digital camera. It should also be noted that a personal computer coupled to an image capture device can alternatively be used. Some laptop computers include a video camera and microphone within a portion of the display frame or cabinet of the device. Alternatively, a video camera and microphone can be coupled to a laptop or other computing device. It is preferable that a laptop or other portable computing device be used, so that the system comprising the image capturing device and the personal computer can efficiently be used in the field to inventory data. A desktop personal computer, video camera and microphone would likely only be useful in this regard if the items to be inventoried can be conveniently brought to the location of the desktop personal computer. Programmable digital cameras have the benefit of enabling the system to be deployed in a portable, compact, and durable package that is readily transportable to each of the items being inventoried. It is contemplated that the programmable digital camera be coupled to the computer to transfer data thereto by either a wired connection, such as through a USB port, or through a wireless connection, such as through a radio frequency or infra red data transmission port.

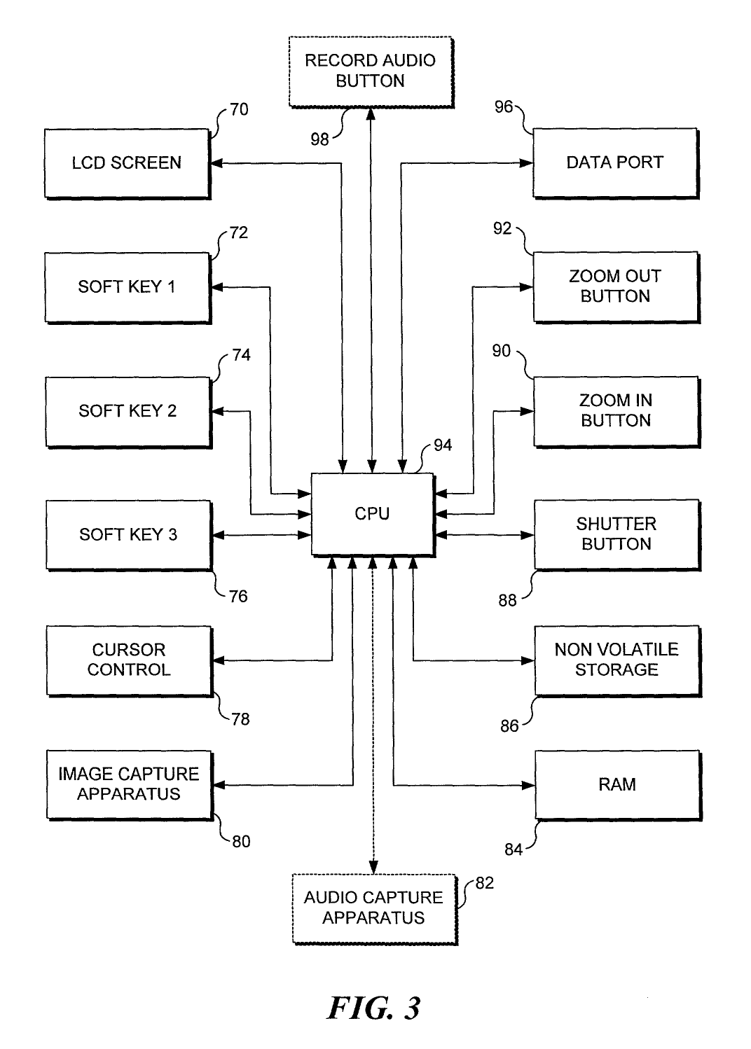

FIG. 3 illustrates the functional elements of a preferred programmable digital camera suitable to implement the present invention. In this embodiment, a Kodak Model DC290™ programmable digital camera is employed. This camera accepts and stores a software program that implements portions of the present invention. The software program was written in source code on a personal computer (not shown), compiled, and the compiled executable file in a format acceptable for execution by the programmable camera was then downloaded from the personal computer into the non-volatile memory of the programmable camera. Such programmable digital cameras are currently readily available. The programmable digital camera of FIG. 3 includes a liquid crystal display (LCD) screen 70, a plurality of soft keys 72, 74, and 76, a cursor control 78, an image capture apparatus 80, an optional audio capture apparatus 82, a volatile RAM 84, a nonvolatile memory 86, a shutter button 88, a zoom in button 90, a zoom out button 92, a processor or central processing unit (CPU) 94, a data port 96, and an optional record audio button 98. Note that all functional elements are controllably connected to CPU 94.

It should be understood that the functional elements displayed in FIG. 3 are simply exemplary of those provided on currently available programmable digital cameras, and should not be considered to be limiting of the present invention. For example, a different type of display (other than an LCD) can be incorporated into a programmable digital camera. Some type of display is required to enable a user to be presented with a list of menu options, so that the user can select a desired option. Similarly, more or fewer soft keys can be incorporated into a programmable digital camera. Preferably (although not essential), soft keys 72-76 are not hard-wired keys, but rather are keys whose functions are controlled by software. Thus, the operation executed upon pressing first soft key 72 can change depending on the programming of the digital camera. At least some control keys are required, although the number and position of the keys may vary depending upon the digital programmable camera employed. For example, some manufacturers integrate the zoom in and zoom out feature into a single control key, rather than using two control keys, as illustrated. While most programmable digital cameras have the ability to capture audio data, as well as image data, audio capture apparatus 82 has been shown as an optional element, because it is not required if audio data are not necessary in describing the items in an inventory. It is expected that rich inventory data including only alphanumeric data and image data would be very useful. The inclusion of audio data is expected to add additional functionality, but is not required. The purpose of data port 96 is to ensure that the rich inventory data generated can be communicated to a computer system, for archival purposes, and for further manipulation and use.

A flow chart 100 in FIG. 4 illustrates the sequence of logical steps employed by the present invention in a preferred embodiment employing a programmable digital camera to capture the image data and audio data. The logic begins in a start block 102, when a user turns the camera on. When the programmable digital camera is energized, a splash screen is displayed to a user, as noted in a block 104. The next step in the logical sequence is represented by a decision block 106, in which the logic determines whether first soft key 72 has been pressed by a user.

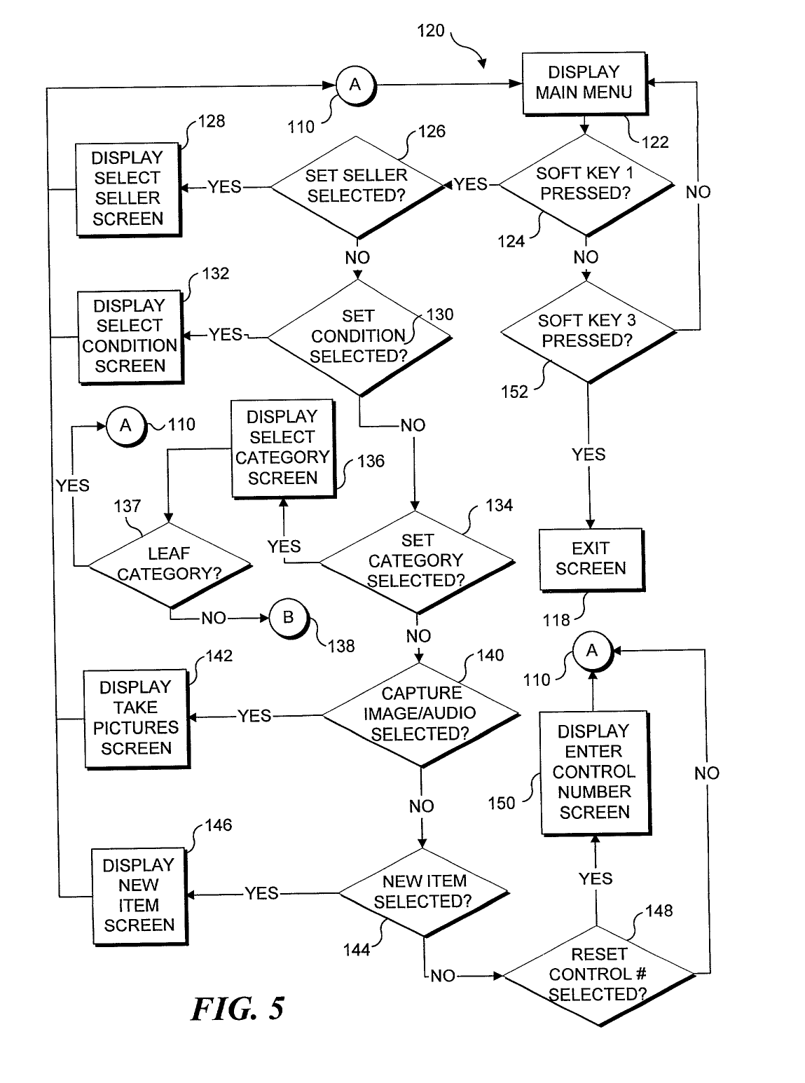

If in decision block 106 the logic determines that first soft key 72 has been pressed, the logic proceeds to a block 108, in which the user is prompted to enter a control number. Once the control number has been entered, the logic proceeds with the steps shown in a flow chart 120 in FIG. 5, as indicated by a connector 110. The additional steps implemented in FIG. 5 are discussed below.

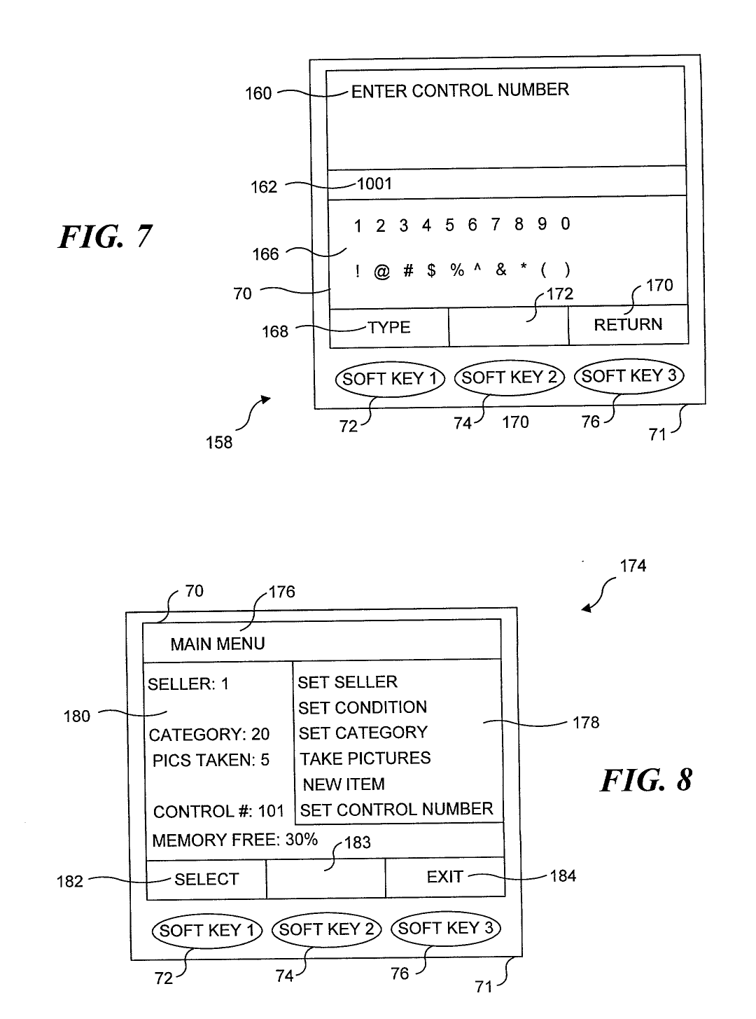

An example of an Enter Control Number screen 158 (shown in FIG. 7) is presented to a user at block 108 (FIG. 4). As illustrated in FIG. 7, a portion 71 of the back of a digital camera includes first soft key 72, second soft key 74, third soft key 76, and LCD screen 70. Note that portion 71 does not necessarily encompass the entire back surface of the digital camera. While not shown in portion 71, it is likely that cursor control 78, shutter button 88, zoom in button 90, and zoom out button 92 will also be disposed on the back of the digital camera, although some cameras may instead position these controls on the top of the camera. Because the soft keys are generally used in association with LCD screen 70, the soft keys are logically disposed adjacent to LCD screen 70, as shown. While not specifically shown, it should be noted that cursor control 78 is used to manipulate a cursor position on LCD screen 70, so that a particular icon or number displayed on LCD screen 70 can be selected by a user. Thus cursor control 78 is preferably also disposed adjacent to LCD screen 70.

LCD screen 70 is divided into a plurality of windows. A window 160 prompts a user to enter a control number. A window 162 displays the control number that was entered to the user. A window 166 provides a plurality of alphanumeric icons that a user can select by manipulating cursor control 78 to move a cursor adjacent to a desired icon. The selected icon or number is entered by pressing first soft key 72, causing the selected icon to appear as if it were “typed” in window 162. A window 166 indicates to a user that the current function of first soft key 72 is the “type” function referred to above. Similarly, a window 168 indicates that the current function of third soft key 76 is to advance the display to a next screen (as determined by the logical sequence controlling the operation of the programmable digital camera) when third soft key 76 is pressed. No information is provided in a window 172, indicating that when Enter Control Number screen 158 is displayed to a user, second soft key 74 has no active function. With respect to the series of logical steps displayed in FIG. 4, if third soft key 76 is pressed when Enter Control Number screen 158 is displayed to a user, the logic proceeds to block 122 in FIG. 5.

It should be noted that the positions of the individual windows shown in Enter Control Number screen 158, and the programmed functions of the soft keys when the Enter Control Number screen is displayed to a user are merely exemplary, and should not be considered as limiting. Other window positions, and variations in the functions performed by the soft keys are clearly contemplated.

Referring once again to FIG. 4, if at decision block 106, the logic determines that first soft key 72 has not been pressed by a user, the logic flows to a decision block 112, in which the logic determines whether second soft key 74 has been pressed by a user. If the logic determines that second soft key 74 has been pressed, the next step in the logical sequence is represented by a block 114, in which a PC connect screen is presented to a user. The PC connect screen is used to transfer rich inventory data that has been collected by the programmable digital camera to a computer system for archival purposes, or for further manipulation or use of the data.

If, at decision block 112, the logic determines that second soft key 74 has not been pressed, a decision block 116 determines whether third soft key 76 has been pressed by the user. If the logic determines that third soft key 76 has been pressed, a block 118 presents an exit screen to the user. If in block 116 the logic determines that third soft key 76 has not been pressed, the logic returns to block 104, and the initial splash screen is once again displayed to the user.

It should be understood that because soft keys 72-76 are programmable keys, the logic can employ different softkeys for different functions, depending on the programming and current state of the programmable digital camera. Accordingly, pressing first soft key 72 could be used to initiate an exit screen while pressing second soft key 74 could enable a user to enter a control number, and third soft key 76 could be used to initiate display of a PC connect screen. Thus, the functions of the specific soft keys 72-76 are simply exemplary, and should not be considered limiting.

In FIG. 5, flow chart 120 illustrates the logical steps employed in an exemplary application of the present invention, in which the programmable digital camera is used to generate rich inventory data for a plurality of items that will be auctioned. Note that the parameters available that the user can select in flow chart 120 of FIG. 5 are appropriate for preparing rich inventory data for items that will be inventoried and then auctioned. Other parameters suitable to alternative applications of the present invention can instead be employed.

In a box 122 of FIG. 5, a main menu is displayed to a user. FIG. 8 illustrates an example of a Main Menu screen 174, which would be displayed to a user using LCD screen 70 on the programmable digital camera. A window 176 advises a user that the main menu is currently being displayed. It should be understood that this main menu is merely exemplary, and other configurations of the main menu can also be employed. The main menu provides a list of options in a window 178 from which a user can select, including identifying a seller, indicating a condition, specifying a category, taking pictures, generating inventory data for a new item, or setting a control number. As discussed above with respect to FIG. 7, the user will use cursor control 78 and the appropriate soft key to select one of the options displayed in window 178.

Referring to FIG. 8, a window 180 provides additional information to a user, such as the number of pictures already taken and the available memory (note that images are memory intensive, and that most digital cameras have a relatively small amount of memory, so that it is important for a user to keep track of memory resources). In this example, window 180 indicates that five pictures have been taken and that 30% of the memory of the programmable digital camera is free. Window 180 also indicates that Seller:1, Category:20, and Control #: 101 have been assigned to the item currently being inventoried. Note that Seller:1 and Category:20 may have been affirmatively selected by a user, or these parameters may have been selected for an item that was just inventoried, and then held in a volatile memory to be applied to the current item, as described in association with FIG. 2. Similarly, Control #:101 may be a control number affirmatively selected by a user via Enter Control Number screen 158 as described in connection with FIG. 7, or Control #:101 may have been automatically incremented from the previous item inventoried, which was assigned a control number 100. Should a user desire to change parameters Seller:1 and Category:20, or Control #:101, the user can do so by selecting either SET CATEGORY or SET CONTROL NUMBER from window 178.

A window 182 indicates that the current function of first soft key 72 is to select an icon from window 178 that has been highlighted using cursor control 78. Similarly a window 184 indicates that the current function of third soft key 76 is enable a user to exit Main Menu screen 174, and to proceed to a next screen as determined by the sequence of logical steps illustrated in FIG. 5, which is an exit screen as indicated by a block 118. Note that second soft key 74 has no assigned function in Main Menu screen 174, as is indicated by an empty window 183 disposed immediately adjacent to second soft key 74.

Referring once again to flow chart 120 of FIG. 5, once the main menu had been displayed to a user at block 122, the logic proceeds to a decision block 124, and the logic determines if a first soft key 72 has been pressed. If first soft key 72 has been pressed, a decision block 126 determines whether SET SELLER has been selected from window 178 of Main Menu screen 174. In decision block 126, if the user has selected SET SELLER, the logic proceeds to a block 128, and a select seller screen is displayed to the user.

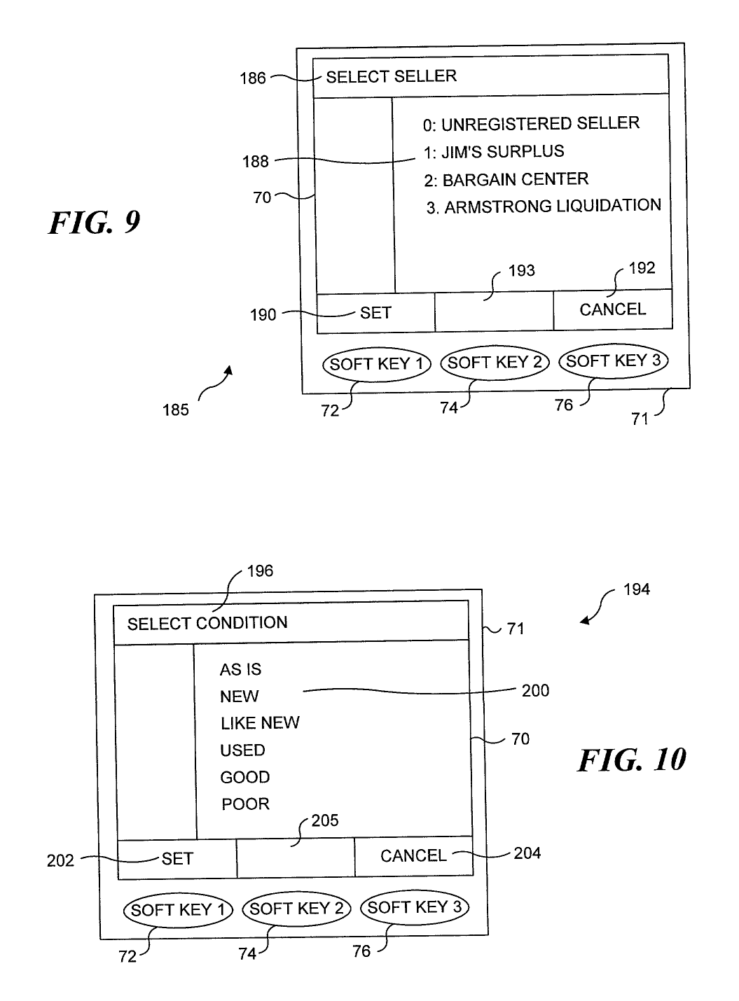

In an example of a Select Seller screen 185 in FIG. 9, a window 186 informs a user that the Select Seller screen is currently being displayed. Because the logic displayed in flow chart 120 is optimized for generating rich inventory data for items that will be auctioned, the Select Seller screen is used to enable a user to select from a pre-populated list of prospective sellers. A window 188 presents such a pre-populated list of sellers to a user. As described above, using cursor control 78 and the appropriate soft key, a user can select a desired seller from this list. Selecting seller 0 from window 188 indicates that the item will be assigned to an unregistered seller. Selecting Seller 1 indicates that the item will be assigned to Jim's Surplus, selecting Seller 2 indicates that the item will be assigned to Bargain Center, and Seller 3 indicates that the item will be assigned for auction by Armstrong Liquidation. Preferably a user will have the ability to add or remove sellers to this pre-populated list, as the changing list of sellers increases or decreases.

A window 190 indicates that the current function of first soft key 72 is to enable a user to select the appropriate seller (after the user has manipulated cursor control 78 to highlight a specific seller in window 188). Once a user has actuated first soft key 72, the seller from window 188 is added to the camera's volatile RAM, and the user is returned to the main menu. A window 192 indicates that the current programmed function for third soft key 76 is to enable a user to exit Select Seller screen 184, without selecting a seller, which means that the seller selected for the item inventoried immediately preceding the current item is kept in the volatile memory, and that seller will be applied to the current item unless a user later returns to Select Seller screen 184 to override the previously selected seller. An empty window 193 immediately above second soft key 74 indicates that in the currently displayed screen, no function is assigned to second soft key 74. As noted with respect to other screens, Select Seller screen 184 and the specific functionality of soft keys 72-76 are merely exemplary, and changes to the locations of specific windows and the functionality of specific soft keys are in accord with the present invention.

Going back to the logical sequence displayed in FIG. 5, once a user has used Select Seller screen 185 to select a seller (or used third soft key 76 to exit from the select seller screen without selecting a seller), the logic returns to block 122, in which the logic causes the main menu to be once again displayed to the user. If, in a decision block 126, the user did not select the Select Seller screen, the next step in the logical sequence is a decision block 130, in which the logic determines whether the user has chosen SET CONDITION from window 178 in Main Menu screen 174. If so, in a block 132, a select condition screen is displayed to the user.

In an exemplary Select Condition screen 194 shown in FIG. 10, a pre-populated list of conditions is presented to a user, enabling the user to select one of the plurality of conditions to describe the condition of the item. A window 196 notifies a user that the select condition screen is currently being displayed. A window 200 presents the pre-populated list of conditions to the user, who can then designate a desired condition by manipulating cursor control 78. A window 202 indicates that the current function of first soft key 72 is to set the designated condition into the camera's volatile RAM, and then return to Main Menu screen 174 (as shown in FIG. 5, the next step in the logical sequence after displaying the select condition screen in block 132 is at block 122, in which the logic causes the main menu to be displayed). It is anticipated that window 200 will enable a user to select from conditions such as “AS IS,” “NEW,” “LIKE NEW,” “USED,” “GOOD,” and “POOR.” It should be understood that these conditions are merely exemplary and are not to be considered limiting of the types of conditions that can be displayed to a user.

A window 204 indicates that the current programmed function for third soft key 76 is to enable a user to exit Select Condition screen 194 without selecting a condition. In this case, if an another item has already been inventoried, the volatile RAM contains the condition selected for the immediately preceding inventoried item, and that previously selected condition will be applied to the current item, unless the user returns to the select condition screen to override the previously selected condition. An empty window 205 immediately above second soft key 74 indicates that in the currently displayed screen, no function is assigned to second soft key 74. As noted with respect to the other screens, the illustrated layout of Select Condition screen 194 and the specific functionality of soft keys 72-76 are merely exemplary.

Once a user has either selected the condition from the select condition screen of FIG. 10, or pressed third soft key 76 to escape from Select Condition screen 194 without selecting a condition, the logic moves to block 122, and the main menu is once again displayed to a user.

Returning to decision block 130 in FIG. 5, if the logic has determined that SET CONDITION from window 188 of the main menu has not been selected by the user, the logic proceeds to a decision block 134, to determine whether a user has selected SET CATEGORY from window 188 of the main menu. If so, in a block 136, a select category screen is displayed to the user.

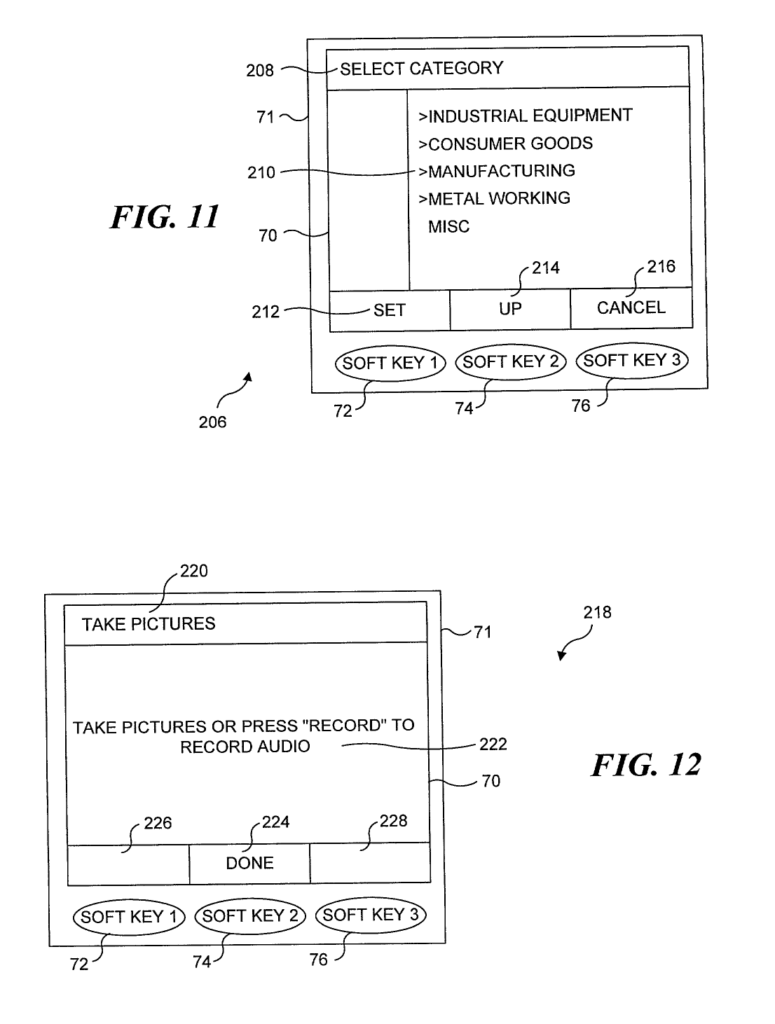

In an exemplary Select Category screen 206 of FIG. 11, a window 208 provides a user confirmation that the screen being displayed is the Select Category screen. A window 210 displays a pre-populated list of categories, which as illustrated includes INDUSTRIAL EQUIPMENT, CONSUMER GOODS, MANUFACTURING, METAL WORKING, and MISC (miscellaneous). A user can select a desired category from the list by manipulating cursor control 78. Once a desired category has been selected, that category is entered into RAM when a user presses first soft key 72, as indicated by a window 212.

Once a user has selected a category, the logic flows to a decision block 137 of the flow chart in FIG. 5, in which the logic determines if the category selected is a “leaf” category (i.e., a category with no subcategories). Note that the “>” icon in window 210 indicates that the category immediately adjacent the icon includes subcategories and is thus not a leaf category. If a category is a leaf category, then no icon is illustrated next to the category title (such as MISC in window 210). If a non-leaf category is selected, a new select category screen is displayed to a user. A new window (not shown) will now display all of the subcategories in the originally selected category. In this manner, the user can navigate through a hierarchical list of categories, which will eventually lead to a leaf category.

A window 214 indicates that the function of second soft key 74 is to enable a user to move “up” from a current category screen to display the next higher level category screen, enabling a user to move up the category hierarchy. Thus, if a user selects METAL WORKING from window 210, a new screen listing the subcategories for METAL WORKING will be displayed. If the user wishes to return to the previous screen (i.e., so that window 210 and the INDUSTRIAL EQUIPMENT, CONSUMER GOODS, MANUFACTURING, METAL WORKING, and MISC categories are again displayed) the user can actuate second soft key 74.

If a user does not wish to select a category, but wants to return to the main menu without selecting a category, a user can actuate third soft key 76, as indicated by a window 216. The third soft key enables a user to exit the category selector without changing the current category stored in the camera's volatile RAM. In this case, any category data stored in the camera's volatile RAM from a item that was just inventoried will be applied to the current item, unless a user returns to the Select Category screen to select a different category.

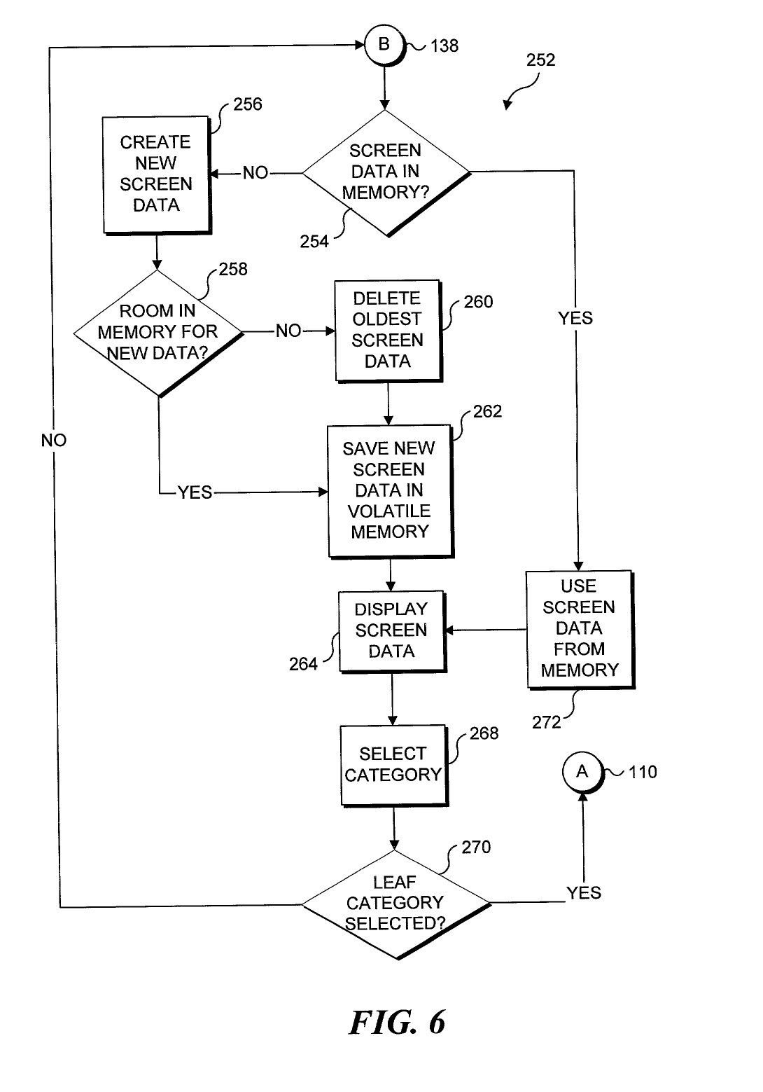

Note that the problem of navigating an arbitrarily deep category list can represent a challenge, given that the screen data structure that enables a user to select a category can take a significant amount of time and memory for the operating system to create. To ameliorate this problem, the system preferably keeps a small list of the screen data structures in memory sorted in regard to how recently the structures were used. When the system needs to display a list for a level in the hierarchy, it first checks to see if a data structure for that list exists, and if so, it uses that data structure instead of creating a new data structure. If a new data structure is created and the designated memory for the list is already full, the least recently used data structure is discarded to make room for the new structure. This approach enables the system to balance the data structure creation time with the efficient use of memory resources. This process is further described in a flow chart 252 illustrated in FIG. 6.

Referring once again to decision block 137 of FIG. 5, if the logic determines that a leaf category has been selected, the logic advances to block 122, and the main menu screen is again displayed. If, in decision block 137, the logic determines that a non-leaf category has been selected, the logic proceeds to connector 138, which connects to a flow chart 252 shown in FIG. 6.

As noted above, flow chart 252 describes the sequence of logical steps employed to balance the creation time of non-leaf category list with the memory use when navigating an arbitrarily deep category list. The logical sequence is initiated in a decision block 254, in which the logic determines if the screen data required to display the subcategories of the non-leaf category selected by a user at block 136 of FIG. 5 already exists in the RAM of the programmable digital camera. The data will not be in the RAM for a first item being inventoried, but for subsequent items, it is possible that the required screen data will have been loaded into RAM. If in decision block 254, the logic determines that the required screen data is already in the memory of the programmable digital camera, a block 272 provides for retrieving the data for use in displaying the required subcategories to a user in a block 264.

If, in decision block 254, the logic determines that the required screen data does not exist in RAM, a block 256 provides for creating the new screen data. A user will experience a short delay as the new screen data are created.

After the new screen data are produced, a decision block 258 determines if room for the newly created screen data exists in a memory cache allocated for storing screen data. Preferably, the memory cache represents only a portion of the volatile RAM resources for the programmable digital camera, so that a separate portion of the volatile RAM is also available for storing the control number, any selected parameters and for use in providing the XML buffer described above. If room in the memory cache is available for the newly generated screen data, a block 262 stores the new screen data in the memory cache allocated for that purpose.

If, in decision block 258, the logic determines that the cache has insufficient capacity for storing the new screen structure, then a block 260 deletes the oldest screen data from the memory cache. The logic then proceeds to block 262 in which the new screen data are stored in the memory cache, which should now have sufficient capacity for storing the newly created screen data.

The next step in the logical sequence of FIG. 6 is described in block 264, in which the newly created screen data are used to display the required subcategories to a user. A block 268 prompts a user to select a new category from the displayed subcategories. When a user has selected a new category, a decision block 270 determines if the newly selected category is a leaf category.

If the newly selected category is a leaf category, the logic moves to block 122 of FIG. 5, in which the main menu is displayed to the user. When the newly selected category is not a leaf category, the sequence of logical steps described above is repeated.

Referring once again to FIG. 5, if in decision block 134, the logic determines that the user has not selected SET CATEGORY from window 178 of the main menu, the logic flows to a decision block 140, and the logic determines if the user has selected TAKE PICTURES from window 178 of the main menu. If so, the logic proceeds to a block 142, and the Take Pictures screen is displayed to the user.

In an exemplary Take Pictures screen 218 shown in FIG. 12, a window 220 indicates to the user that the screen displayed is the Take Pictures screen, and a window 222 prompts a user to actuate either shutter button 88 (see FIG. 3) to take a picture, or to press optional record audio button 98 (see FIG. 3) to record audio data. When the user is done taking pictures, the user presses second soft key 74, as indicated by a window 224, and the logic will return to block 122 of FIG. 5, which displays the main menu. As discussed above, in a preferred embodiment, image data and audio data are stored in separate files. Further, the image data and audio data are preferably stored in the camera's permanent nonvolatile memory, rather than in the camera's volatile RAM.

It should also be noted that once a user has selected TAKE PICTURES from window 178 of the main menu, in addition to displaying Take Pictures screen 218, the logic controlling the programmable digital camera automatically executes the step described in block 38 of FIG. 2, i.e., the contents of the volatile RAM (which includes any selected parameters such as seller, category, condition; as well as the unique control number for the current item) are copied into an XML buffer that has been established. When a user indicates that no more image data or audio data will be collected for the current item (by actuating second soft key 74), the logic controlling the programmable digital camera not only displays the main menu, but also automatically executes the logical steps described in block 42 of FIG. 2, i.e., any image data and audio data file names will be added to the XML buffer.

If, at decision block 140 of FIG. 5, the logic determines that the user has not selected TAKE PICTURES from window 178 of the main menu, a decision block 144 determines whether the user has selected NEW ITEM from window 178 in the main menu. If NEW ITEM has been selected, the logic proceeds to a block 146, and a New Item screen is displayed to a user.

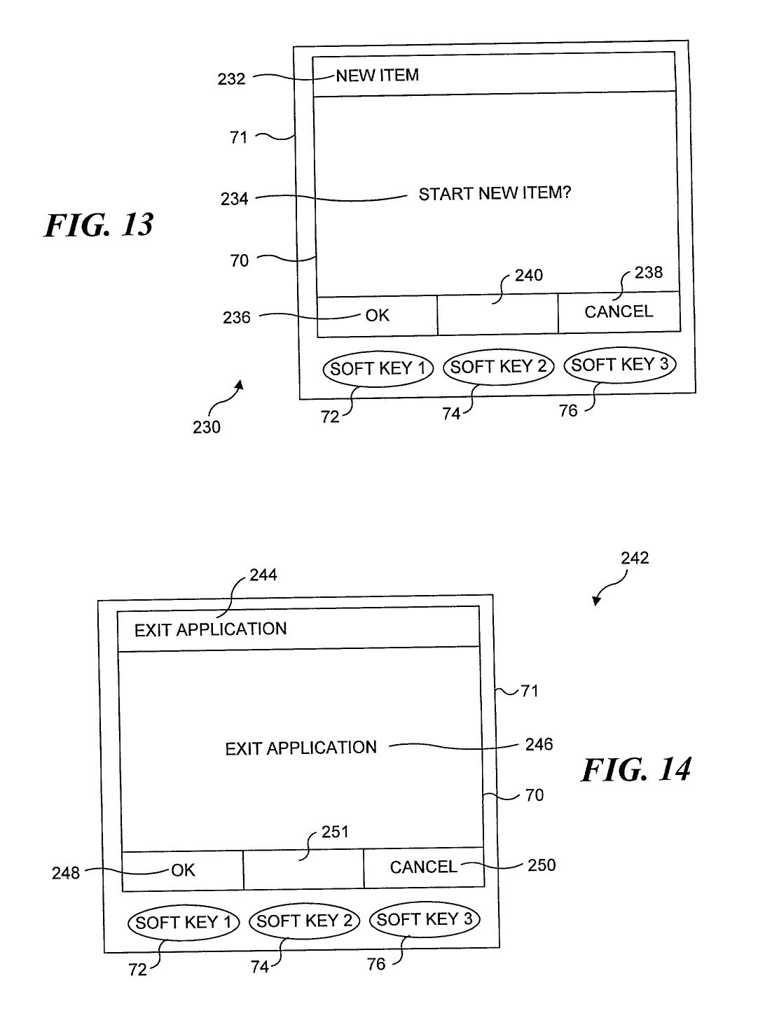

Referring to FIG. 13, a window 232 notifies a user that the screen currently displayed is a New Item screen 230. A window 234 prompts a user to affirm that a new item is to be inventoried by actuating first soft key 72 (note that a window 236 adjacent to first soft key 72 displays “OK”), and the logic advances to block 122 (FIG. 5), in which the main menu is again displayed. Alternatively, a user can actuate third soft key 76 to exit the New Item screen and return to the main menu (note that a window 238 adjacent to third soft key 76 that displays “CANCEL”) without causing a new item to be selected. An empty window 240 indicates that second soft key 74 has no functionality in New Item screen 230.

At the New Item screen, when a user actuates first soft key 72 verifying that a new item is to be inventoried, the logic controlling the programmable digital camera not only displays the main menu, but also automatically executes the logical steps described in blocks 44, 46, 50, and 52 of FIG. 2. The logic controlling the programmable digital camera automatically adds the ending item tag to the XML buffer (block 44), and then appends the contents of the XML buffer to a master file (preferably named “bp.xml”) in the nonvolatile storage (as per block 46). This master file now contains all the information required to correlate all the data collected, including the images and the sounds into the single record that greatly facilitates organizing these data. The logic then clears the XML buffer (as per block 50), and increments the current control number (as per block 52). All other settings in the volatile RAM (any selected parameters) are unchanged. In this way, the previous item's settings for seller, category, and condition are carried over. In most situations, an auctioneer will have a series of items in which the category, condition, and seller are the same, so carrying these setting over from the previous item represents a productivity enhancement.

Returning once again to FIG. 5, if in decision block 144 the user has not selected NEW ITEM from window 178 in the main menu, a decision block 148 determines whether the user has selected SET CONTROL NUMBER from window 178. If not, the logic flows to block 122, in which the main menu is once again displayed to the user. If, in decision block 148, the logic determines that the user has selected SET CONTROL NUMBER from window 178 of the main menu, then the logic proceeds to a block 150, and the Enter Control Number screen is displayed to a user. As discussed noted above, FIG. 7 illustrates the Enter Control Number screen.

Returning once again to decision block 124 of FIG. 5 (at which point the main menu is currently being displayed to a user), if the logic determines that first soft key 72 has not been pressed by the user, the logic proceeds to decision block 152 and determines whether third soft key 76 has been pressed by the user. If third soft key 76 has not been pressed by the user, the logic returns to block 122 to display the main menu. If, at decision block 152, the logic determines that third soft key 76 has been pressed by the user, the logic flows to block 118 and an Exit Screen is presented to the user. Note that second soft key 74 has no functionality when the main menu is displayed.

In an exemplary Exit screen 242 shown in FIG. 14, the user is alerted that the Exit Screen has been selected in a window 244, and a window 246 queries the user to determine if the user wishes to exit the application. A window 248 indicates that by actuating first soft key 72, the user accepts the exit application option, and the application is terminated. If the user is not yet ready to exit the application, the user can select third soft key 76 to cancel (note a window 250), and the logic illustrated in FIG. 5 flows to block 122 to display the main menu. An empty window 251 adjacent to second soft key 74 indicates that the second soft key has no functionality in Exit screen 242.

A Summary of Steps Used to Generate Rich Inventory Data for Items to be Auctioned

1. User enters in a unique control number for a first item.

2. The user selects a seller or consignor from a pre-populated list of sellers or consignors.

3. The user selects the condition of the item from a pre-populated list of conditions.

4. The user selects a category for the item from a pre-populated list of categories.

5. The user optionally takes pictures of the item.

6. The user optionally records a verbal description of the item, noting any special or relevant details.

7. The user causes the system to prepare for entry of data for the next item.

8. The user begins to produce inventory data for the next item. Note that the system automatically will increment the control number from that used for the prior item, and the consignor, the condition, and the category selected for the prior item will be applied by default to the new item. The user may accept these default settings, or override the default settings. The process is repeated until all items have been inventoried according to the above steps.

Exemplary XML

```
  XML buffer after block 38 of FIGURE 2.
<ITEM CATEGORY=“3” SELLER=“100” CONTROL=“101” CONDITION=“0”>
  XML buffer after block 42 of FIGURE 2.
<ITEM CATEGORY=“3” SELLER=“100” CONTROL=“101” CONDITION=“0”>
  <CAPTURE IMAGE=“P001330”/>
  [Note that the image file is named automatically by the programmable
digital camera; the image file name is thus provided in this XML file. In contrast,
the audio file is specified by the software program.]
  XML buffer after block 44 of FIGURE 2.
<ITEM CATEGORY=“3” SELLER=“100” CONTROL=“101” CONDITION=“0”>
  <CAPTURE IMAGE=“P001330”/>
  <CAPTURE IMAGE=“P001331”/>
</ITEM>
```

Although the present invention has been described in connection with the preferred form of practicing it and modifications thereto, those of ordinary skill in the art will understand that many other modifications can be made to the present invention within the scope of the claims that follow. Accordingly, it is not intended that the scope of the invention in any way be limited by the above description, but instead be determined entirely by reference to the claims that follow.

The invention in which an exclusive right is claimed is defined by the following:

1. A method for generating rich inventory data for a plurality of items, such that any image data, any audio data, and any alphanumeric data relating to a specific inventory item are automatically correlated and associated with that specific inventory item, comprising the steps of:
(a) assigning a unique identifier to a specific item to be inventoried;
(b) enabling a user to select at least one parameter relating to said specific item from among a plurality of parameters, said at least one parameter comprising alphanumeric data;
(c) capturing at least one of an image and audio data relating to said specific item;
(d) storing said unique identifier, said at least one parameter, and said at least one of the image and the audio data relating to said specific item in a memory; and
(e) creating a data set in which a unique identifier, at least one parameter comprising alphanumeric data, and at least one of an image and audio data relating to each of the plurality of items are stored in the memory, by repeating steps (a) through (d) for each of remaining item in the plurality of items.

2. The method of claim 1, wherein the step of storing comprises the steps of:
(a) storing said unique identifier and the alphanumeric data comprising said at least one parameter in a volatile memory; and
(b) storing said at least one of the image data and the audio data in a nonvolatile memory.

3. The method of claim 2, wherein the step of storing further comprises the steps of:
(a) copying said identifier and said alphanumeric data from said volatile memory into a buffer memory;
(b) including a file name of any image data captured relating to a current specific item in said buffer memory;
(c) including a file name of any audio data captured relating to the current specific item in said buffer memory a file name of any audio data captured relating to said specific item;
(d) copying a contents of said buffer memory to said nonvolatile memory; and
(e) flushing said buffer memory before inventorying a next item from among the plurality of items.

4. The method of claim 3, wherein:
(a) the step of copying said identifier and said alphanumeric data from said volatile memory into the buffer memory comprises the step of including said identifier and said alphanumeric data in an extensible markup language fragment;
(b) the step of including within said buffer memory the file name of any image data captured comprises the step of including said file name in said extensible markup language fragment;
(c) the step of including within said buffer memory a file name of any audio data captured comprises the step of including said file name in said extensible markup language fragment; and
(d) the step of copying the contents of said buffer memory to said nonvolatile memory comprises the step of adding an end tag to said extensible markup language fragment, thereby generating a complete set of extensible markup language data that is copied to a master extensible markup language file in said nonvolatile memory, so that each specific item inventoried generates a unique set of extensible markup language data stored in said master extensible markup language file.

5. The method of claim 1, wherein:
(a) the step of storing said unique identifier in the memory comprises the step of storing said unique identifier in a volatile memory;
(b) the step of storing said alphanumeric data in the memory comprises the step of storing said alphanumeric data in said volatile memory; and
(c) the step of creating a data set comprises, for each successive unique item, the steps of:
(i) copying said identifier and said alphanumeric data from said volatile memory into the buffer memory, said identifier and said alphanumeric data remaining in said volatile memory;
(ii) including within said buffer memory any image data captured relating to a specific item being currently inventoried, and a link to any image data captured relating to said specific item being currently inventoried;
(iii) including within said buffer memory any audio data captured relating to said specific item being currently inventoried, and a link to any audio data captured relating to said specific item being currently inventoried; and
(iv) moving a contents of said buffer memory to a nonvolatile memory before inventorying a next item from among the plurality of items.

6. The method of claim 5, wherein after generating the rich inventory data for any specific item, and before the generating rich inventory data for the next item, said volatile memory is not flushed, so that the unique identifier for a specific item that has just been inventoried remains in said volatile memory; further comprising the step of automatically incrementing said unique identifier for the specific item that has just been inventoried, so that a new unique identifier is provided for the next item to be inventoried.

7. The method of claim 1, wherein the step of assigning comprises the step of enabling a user to assign a unique identifier to the next item to be inventoried.

8. The method of claim 5, wherein after generating the rich inventory data for any specific item, and before generating the rich inventory data for the next item, said volatile memory is not flushed, so that any parameters selected for the specific item that has just been inventoried remain in said volatile memory; and wherein the step of enabling a user to select at least one parameter comprises the steps of:
(a) initially assigning any parameters stored in said volatile memory to the next item to be inventoried; and
(b) enabling a user to remove and change any parameters so assigned.

9. The method of claim 1, wherein the step of enabling a user to select at least one parameter comprises the step of providing a plurality of parameters that are relevant to a class of items that are to be inventoried.

10. The method of claim 9, wherein said class of items that are to be inventoried comprise items that are to be auctioned; and wherein the step of enabling the user to select at least one parameter further comprises the step of enabling the user to select a parameter the describes a physical condition of said specific item.

11. The method of claim 10, wherein the class of items that are to be auctioned are to be assigned to a consignor, and wherein the step of enabling the user to select at least one parameter comprises the step of enabling the user to select a consignor for the specific item, from among a plurality of different consignors.

12. The method of claim 10, wherein the step of enabling a user to select at least one parameter comprises the step of enabling a user to select a category that describes said specific item.

13. The method of claim 1, wherein the step of enabling a user to capture one of an image and audio data relating to said specific item comprises the step of creating a separate data file for each different type of data captured, such that any image data collected are saved as an image data file and any audio data that are collected are saved as an audio data file.

14. The method of claim 13, wherein the step of creating a separate data file for each different type of data captured comprises the step of using said identifier as a portion of a name of any separate data file.

15. The method of claim 1, further comprising the step of providing a programmable system capable of capturing and storing data relating to at least one of an image, audio, and a set of alphanumeric characters.

16. The method of claim 1, wherein the step of providing a programmable system comprises the step of providing at least one of:
(a) a programmable digital camera; and
(b) a personal computer that is operatively coupled to an image capturing device.

17. The method of claim 16, further comprising the step of coupling the programmable digital camera to a computer system by one of a wired and a wireless connection, to transfer data captured when generating the rich inventory data.

18. The method of claim 1, wherein the step of enabling the user to select comprises the step of prompting the user to choose at least one parameter from among a plurality of different parameters that are displayed to the user.

19. A method for generating rich inventory data, comprising the steps of:
(a) providing a system programmed for capturing and storing at least one of image data, audio data, and alphanumeric data for items being inventoried;
(b) assigning a unique identifier to a specific item being inventoried; said unique control number being associated with a specific item being inventoried;
(c) enabling a user to select at least one parameter relating to said specific item from among a plurality of parameters to specify alphanumeric data associated with the specific item;
(d) capturing at least one of image data and audio data relating to said specific item with said system;
(e) storing the alphanumeric data, and said at least one of the image data and the audio data in association with the unique identifier for the specific item, so that alphanumeric data, and any image data and/or audio data stored are readily correlated with the unique identifier, and thus, with the specific item; and
(f) repeating steps (b)-(e) for each additional item to be inventoried.

20. The method of claim 19, wherein said step of assigning comprises the step of automatically incrementing said unique identifier for each successive item being inventoried.

21. The method of claim 19, further comprising the step of creating a data set for the items being inventoried, said data set including the unique identifier assigned to each item, any alphanumeric data relating to the item, a name of any image data file in which any image data relating to the item are stored, and a name of any audio data file in which any audio data relating to the item are stored, said data set being saved to a master file in a nonvolatile memory.

22. The method of claim 21, wherein the step of creating a data set comprises the step of creating an extensible markup language buffer in a volatile memory of the system.

23. The method of claim 22, wherein the step of saving said data set to a master file in the nonvolatile memory comprises the steps of appending contents of the extensible markup language buffer to said master file; and then clearing the extensible markup language buffer in said volatile memory.

24. The method of claim 19, wherein the step of enabling the user to select at least one parameter comprises the step of enabling the user to select from among a plurality of parameters that describe a condition of said specific item.

25. The method of claim 19, wherein the step of enabling the user to select at least one parameter comprises the step of enabling the user to select from among a plurality of parameters related to a category of items in which said specific item is included.

26. The method of claim 19, wherein the step of enabling the user to select at least one parameter comprises the step of enabling the user to indicate a consignor to which the item will be assigned from among a plurality of different consignors.

27. The method of claim 19, wherein the step of enabling a user to select at least one parameter comprises the step of storing each selected parameter in a volatile memory, such that each selected parameter is applied to a next item to be inventoried, unless a user affirmatively elects not to apply a selected parameter stored in said volatile memory to said next item to be inventoried.

28. The method of claim 19, wherein the step of enabling a user to capture one of image data and audio data relating to said specific item comprises the step of creating a separate data file for each different type of data captured, such that any image data collected are saved as an image data file and any audio data collected are saved as an audio data file, and storing any image data file and audio data file thus created into said volatile memory.

29. The method of claim 28, wherein the step of creating a separate data file for each different type of data captured comprises the step of employing said unique identifier in a name for each file created, so that for a specific item that has been inventoried, any image data file and any audio data file will have a file name that includes the unique identifier, but different file extensions.

30. The method of claim 19, wherein the step of providing the system comprises the step of providing a programmable digital camera.

31. The method of claim 30, wherein the step of capturing comprises at least one of the step of translating an image of the item being inventoried into an image data file and the step of recording a verbal input supplied to a microphone to an audio data file.

32. The method of claim 31, wherein the step of enabling the user to select comprises the step of displaying a menu that includes available parameters from which the user chooses to define the alphanumeric data for each item being inventoried.

33. The method of claim 32, further comprising the step of enabling a user to transfer rich inventory data for each item that has been inventoried comprising at least one of the image data file, the audio data file, and the alphanumeric data for the item, to a computer system in correlation with said unique identifier for the item, using one of a wired and a wireless connection with the computer system.

34. An article of manufacture on which machine instructions are stored that are adapted to be executable by a processor, comprising:
(a) a memory medium; and
(b) a plurality of machine instructions comprising a computer program, which are stored on the memory medium, said plurality of machine instructions when executed by a processor, causing said processor to:
(i) enable a unique identifier to be assigned to a specific item to be inventoried;
(ii) enable a user to select at least one parameter relating to said specific item from among a plurality of parameters, producing alphanumeric data related to said specific item;
(iii) facilitate capturing at least one of image data and audio data related to said specific item;
(iv) correlate said unique identifier with said alphanumeric data and said at least one of the image data and the audio data related to said specific item; and
(v) create a data set comprising rich inventory data for a plurality of items being inventoried by repeating steps (i)-(iv) for each additional item to be inventoried.

35. The article of manufacture of claim 34, wherein the machine instructions cause the processor to generate separate image data and audio data files when both the image data and the audio data are captured for a specific item, said audio data not being included in the image data file.

36. The article of manufacture of claim 35, wherein the machine instructions cause the processor to create an extensible markup language data set for each item inventoried that includes said unique identifier for the item, said alphanumeric data for the item, a name of any image data file generated by capturing an image of the item, and a name of any audio data file generated by capturing audio data for the item, and to save said extensible markup language data set into a master extensible markup language file in a nonvolatile memory.

37. The article of manufacture of claim 34, wherein the machine instructions cause said processor to store said unique identifier and rich inventory data in a volatile memory separate from said data set, so that after the rich inventory data for each item are generated and stored in the volatile memory, and before the rich inventory data for a next item are generated and stored in the volatile memory, said unique identifier is automatically incremented by the processor.

38. The article of manufacture of claim 34, wherein for each item being inventoried, the machine instructions cause the processor to store any selected parameters in a volatile memory separate from said data set, so that after the rich inventory data for the item is generated and stored, any selected parameters stored in said volatile memory are applied to a next item being, unless a user selectively changes a parameter for the next item.

39. A system for enabling rich inventory data to be generated for each item of a plurality of items, such that any image data, any audio data, and any alphanumeric data relating to a specific item are automatically correlated to said specific item, comprising:
(a) a memory in which a plurality of machine instructions defining a sequence of logical steps for generating said rich inventory data are stored;
(b) a display;
(c) an image capture device; and
(d) a processor that is controllably coupled to the display and to the image capture device by one of a wired and a wireless connection, and coupled to the memory to access the machine instructions, said processor executing said machine instructions and thereby implementing a plurality of functions, including:
(i) enabling a unique identifier to be assigned to a specific item being inventoried;
(ii) enabling a user to select at least one parameter relating to said specific item from among a plurality of parameters;
(iii) enabling a user to capture at least one of image data and audio data relating to said specific item;
(iv) storing said at least one parameter, and said at least one of the image data and the audio data in memory, in association with the unique identifier for the specific item being inventoried; and
(v) creating a data set of the rich inventory data by repeating steps (i)-(iv) for each additional item to be inventoried.

40. The system of claim 39, wherein said processor is included in a portable personal computer that is coupled to the image capturing device by one of a wired and a wireless connection.

41. The system of claim 39, wherein said image capturing device comprises a programmable digital camera.
